(19) United States
(12) Patent Application Publication
(10) Pub. No.: US 2025/0271212 A1
(43) Pub. Date: Aug. 28, 2025

(54) METALLURGICAL FURNACE HOT PLATE WITH COOLING FEATURES

(71) Applicant: Systems Spray-Cooled, Inc., Smyrna, TN (US)

(72) Inventor: Scott A. FERGUSON, Murfreesboro, TN (US)

(21) Appl. No.: 18/584,808

(22) Filed: Feb. 22, 2024

(51) Int. Cl. F27B 3/24; F27D 1/12; F27D 9/00

(52) U.S. Cl. CPC F27B 3/24; F27D 1/12; F27D 2009/0016

(57) ABSTRACT

A sidewall or roof for a metallurgical furnace is disclosed herein. The sidewall has a cover plate and a hot plate coupled in a spaced apart relation to the cover plate forming an inner volume of the sidewall. The hot plate is configured to contact molten material. A spray cool system is disposed in the interior volume of the sidewall and configured to spray coolant on the hot plate. The hot plate has an inner surface configured to face an interior volume of the metallurgical furnace. The hot plate has an outer surface exposed to the inner volume of the sidewall. A plurality of cooling features extend from the outer surface of the hot plate in a spaced apart relationship. The cooling features are configured to enhance the cooling of the hot plate by the spray cool system.

### BACKGROUND OF THE DISCLOSURE

### Field of the Disclosure

Embodiments of the present disclosure relates generally to a hot plate having cooling features for a metallurgical furnace, and more particularly to a furnace sidewall or roof having a hot plate with cooling features.

### Description of the Related Art

Metallurgical furnaces (e.g., an electric arc furnace or a ladle metallurgical furnace) are used in the processing of molten metal materials. The electric arc furnace heats charged metal in the furnace by means of an electric arc from a graphite electrode. The electric current from the electrode passes through the charged metal material forming a molten bath of the metal materials. The furnaces house the molten materials during the processing of the molten materials forming molten steel and slag (a stony waste material).

A metallurgical furnace as above described is typically made of steel, aluminum, aluminum base alloys, copper, copper base alloys and metals having similar thermal characteristics. The surface of the sidewall and roof exposed to the molten material in the furnace become very hot during processing of the molten materials. To dissipate heat from the furnace sidewalls and roof exposed to the molten materials, the metallurgical furnace may have cooling systems. One type of cooling system is a spray cooling system. The spray cool system sprays water on the hot surface in the interior portion of the sidewall and/or the roof of the furnace. The sprayed water is then collecting in a drain and pumped from the sidewall and/or. However, pumping the water into the spray cooling system, then pumping the water out from the drain, as well as the usage and treatment of the water comes is expense.

Therefore, there is a need for an improved cooling system for a metallurgical furnaces.

### SUMMARY

A sidewall and/or roof of a metallurgical furnace, and a metallurgical furnace having the same are described therein which have cooling features that promote efficient use of cooling fluid. The efficient use of cooling fluid enabled through the use of cooling features formed on the sidewall and/or roof of the metallurgical furnace reduces operating costs while improving cooling performance, which ultimately improves the performance of the furnace.

In one example, a sidewall for a metallurgical furnace is provided. The sidewall has a cover plate and a hot plate. The hot plate is coupled in a spaced apart relation to the cover plate, thus forming an inner volume of the sidewall. The hot plate has an inner surface configured to face an interior volume of the metallurgical furnace. The hot plate has an outer surface exposed to the inner volume of the sidewall. The inner surface of hot plate is configured to face molten material when present in the furnace. A spray cool system is disposed in the inner volume of the sidewall and configured to spray coolant on the outer surface of the hot plate. A plurality of cooling features extend from the outer surface of the hot plate in a spaced apart relationship. The cooling features are configured to enhance the cooling of the hot plate by the spray cool system.

In another example, a metallurgical furnace roof is provided. The roof has a cover plate and a hot plate. The hot plate is coupled in a spaced apart relation to the cover plate, thus forming an inner volume of the roof. The hot plate has an inner surface configured to face an interior volume of the metallurgical furnace. The hot plate has an outer surface exposed to the inner volume of the roof. The inner surface of hot plate is configured to face molten material when present in the furnace. A spray cool system is disposed in the inner volume of the roof and configured to spray coolant on the outer surface of the hot plate. A plurality of cooling features extend from the outer surface of the hot plate in a spaced apart relationship. The cooling features are configured to enhance the cooling of the hot plate by the spray cool system.

In yet another example, a metallurgical furnace is provided. The metallurgical furnace has a hearth, a sidewall sitting on the hearth and a roof disposed on the sidewall. The hearth, sidewall and roof define an interior volume of the metallurgical furnace. The interior volume configured for processing molten material. The at least one of the sidewall and roof has a cover plate and a hot plate coupled together in a spaced apart relation. An inner volume of the sidewall and/or roof is defined between the cover and hot plates. The hot plate is configured to face molten material when disposed within the furnace. A spray cool system is disposed in the interior volume and configured to spray coolant on the hot plate. The hot plate has an inner surface configured to face an interior volume of the metallurgical furnace. The hot plate has an outer surface exposed to the inner volume. A plurality of cooling features extend from the outer surface of the hot plate in a spaced apart relationship. The cooling features are configured to enhance the cooling of the hot plate by the spray cool system.

In yet another embodiment, a method for cooling a sidewall and/or roof of a metallurgical furnace is provided. The metallurgical furnace has a hearth, a sidewall sitting on the hearth and a roof disposed on the sidewall. The hearth, sidewall and roof define an interior volume of the metallurgical furnace. The interior volume configured for processing molten material. The sidewall and/or roof has a cover plate and a hot plate coupled together in a spaced apart relation forming an inner volume. The hot plate is configured to face the inner volume. A spray cooled system is disposed in the interior volume and configured to spray coolant on an outer surface of the hot plate. An outer surface of the hot plate is configured to face an interior volume of the metallurgical furnace. A plurality of cooling features extend from the outer surface of the hot plate in a spaced apart relationship wherein the cooling features are configured to enhance the cooling of the hot plate by the spray cool system.

### BRIEF DESCRIPTION OF THE DRAWINGS

So that the way the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a side elevation view of a metallurgical furnace.

FIG. 2A illustrates a partial sectional view the sidewall of the metallurgical furnace of FIG. 1.

FIG. 2B illustrates a partial sectional view of the roof of the metallurgical furnace of FIG. 1.

FIGS. 3A-3F are schematic elevation views of various patterns of cooling features which may be utilized on the sidewall illustrated in FIG. 2A or roof illustrated in FIG. 2B.

FIGS. 4A-4B are schematic plan views of topological patterns for the cooling features which may be utilized on the sidewall illustrated in FIG. 2A or roof illustrated in FIG. 2B.

FIGS. 5A and 5B illustrate possible shape variations for the cooling features.

To facilitate understanding, identical reference numerals have been used, where possible, to designate identical elements that are common to the figures. It is contemplated that elements disclosed in one embodiment may be beneficially utilized with other embodiments without specific recitation.

### DETAILED DESCRIPTION

The present invention is directed to a furnace sidewall and/or roof having cooling features disposed on an outer surface of a hot face to enhance spray cooling of the sidewall and/or roof. The sidewall and roof of the metallurgical furnace includes a spray-cooled hot plate having an inner surface that faces an interior volume of the furnace. Cooling features are disposed on the outer surface of the hot plate which is exposed to coolant sprayed thereon by the spray cool system. The cooling features enhance the ability to remove heat and thereby cool the hot plate. The cooling features protect the hot plate from overheating, thereby extending the service life of the hot plate. Moreover, the cooling features desirably promote the adhesion of slag on inner surface of the hot plate, which also extends the service life of the hot plate.

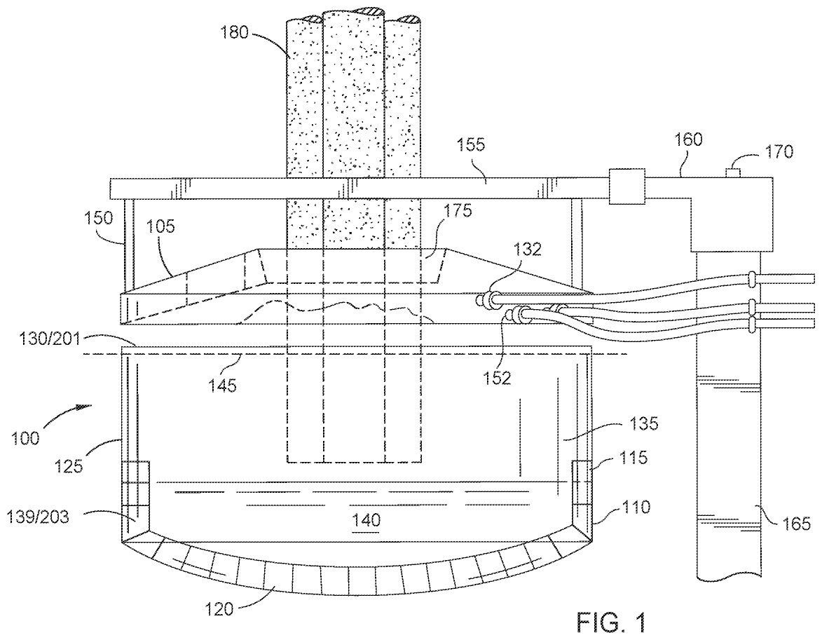

FIG. 1 illustrates a side elevation view of a metallurgical furnace 100 having a roof 105 removably disposed on a furnace body 110. The furnace body 110 includes a sidewall 125 disposed on a hearth 115. The hearth 115 is lined with refractory brick 120. One or both of the roof 105 and sidewall 125 may be spray-cooled, as further described below. The sidewall 125 has a top 130 and a bottom 139. The roof 105 is moveably disposed on the top 130 of the sidewall 125. The roof 105 and furnace body 110 enclose an interior volume 135 of the metallurgical furnace 100. The interior volume 135 may be loaded or charged with material 140, e.g., metal, scrap metal, or other meltable material, which is to be melted within the metallurgical furnace 100.

The metallurgical furnace 100, including the furnace body 110 and the spray-cooled roof 105, is rotatable along a tilt axis 145. The metallurgical furnace 100 may be tilted in a first direction about the tilt axis 145 toward the slag door (not shown) multiple times during a single batch melting process, sometimes referred to as a “heat”, to remove slag. Similarly, the metallurgical furnace 100 may be tilted in a second direction about the tilt axis 145 towards a tap spout (not shown) multiple times during a single batch melting process including one final time to remove the molten material 140.

Roof lift members 150 may be attached at a first end to the roof 105. The roof lift members 150 may be chains, cables, ridged supports, or other suitable mechanisms for supporting the roof 105. The roof lift members 150 may be attached at a second end to one or more mast arms 155. The mast arms 155 extend horizontally and spread outward from a mast support 160. The mast support 160 may be supported by a mast post 165. A coupling 170 may attach the mast post 165 to the mast support 160. The mast support 160 may rotate about the coupling 170 and the mast post 165. Alternately, the mast post 165 may rotate with the mast support 160 for moving the roof lift members 150. In yet other examples, roof lift members 150 may be aerially supported to move the roof 105. In one embodiment, the roof 105 is configured to swing or lift away from the sidewall 125. The roof 105 is lifted away from the sidewall 125 to expose the interior volume 135 of the metallurgical furnace 100 through the top 130 of the sidewall 125 for loading material therein.

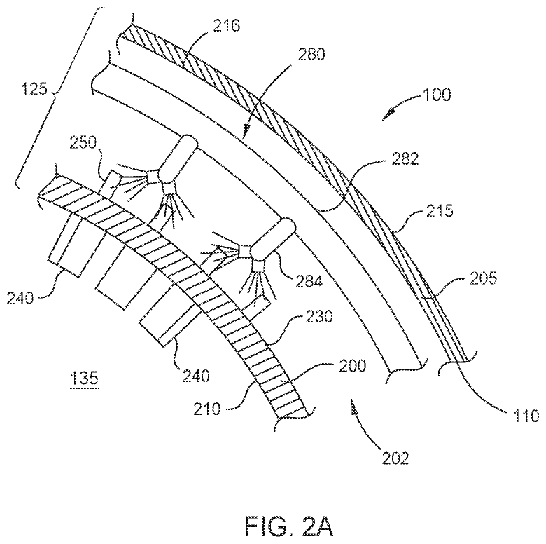

At least the sidewall 125 of the furnace body 110 may be ring, oval or circular-shaped when viewed from a top plan view, of which a portion is shown in FIG. 2. Likewise, the roof 105 has a shape complimentary to that of the sidewall 125 so that the interior volume 135 may be enclosed.

A central opening 175 may be formed through the roof 105. Electrodes 180 extend through the central opening 175 from a position above the roof 105 into the interior volume 135. During operation of the metallurgical furnace 100, the electrodes 180 are lowered through the central opening 175 into the interior volume 135 of the metallurgical furnace 100 to provide electric arc-generated heat to melt the material 140.

The roof 105 may be coupled to a coolant supply 132 and one or more coolant drains 152. The coolant supply 132 may provide coolant to the roof 105. The coolant drains 152 may remove the spent coolant from the roof 105. The roof 105 may further include an exhaust port to permit removal of fumes generated within the interior volume 135 of the metallurgical furnace 100 during operation. The sidewall 125 and the roof 105 will be discussed further below with respect to FIGS. 2A and 2B respectively.

FIG. 2A illustrates a partial sectional view of the sidewall 125 of the metallurgical furnace 100 of FIG. 1. The sidewall 125 comprises a hot plate 200 and a cover plate 205, both of which are shown in cross-section in FIG. 2A. The hot plate 200 is coupled in a spaced apart relation to the cover plate 205. The hot plate 200 and the cover plate 205 have a ring, oval or circular-shape, which forms the sidewall 125. An inner volume 202 of the sidewall 125 is defined between the hot plate 200 and the cover plate 205.

The cover plate 205 is fabricated from steel or other suitable material. The cover plate 205 has an exterior surface 215 and an interior surface 216. The exterior surface 215 faces the ambient environment where the metallurgical furnace 100 is utilized. The interior surface 216 is exposed to the inner volume 202 of the sidewall 125 and faces the cover plate 205.

The hot plate 200 is fabricated from steel or other suitable material. The hot plate 200 has an inner surface 210 and an outer surface 230. The hot plate has an upper surface 201 and a lower surface 203. In operation, the upper surface 201 is oriented above the lower surface 203. The inner surface 210 faces the interior volume 135 of the metallurgical furnace 100 (shown in FIG. 1). The outer surface 230 is exposed to the inner volume 202 of the sidewall 125 and faces the cover plate 205.

A plurality of slag retainers 240 may be coupled to the inner surface 210 of the hot plate 200. The slag retainers 240 project from the inner surface 210 of the hot plate 200 into the interior volume 135 of the metallurgical furnace 100. The slag retainers 240 is configured to trap slag produced by a batch melting process performed in the metallurgical furnace 100.

A spray cool system 280 is disposed in the inner volume 202 of the sidewall 125 between the cover plate 205 and the hot plate 200. The spray cool system 280 has a header 282 and a plurality of nozzles 284. The plurality of nozzles 284 are coupled to the header 282. Liquid, such as water, is provided through the header 282 to the nozzles 284 such that the liquid may be sprayed through the nozzles 284 onto the outer surface 230 of the hot plate 200. The liquid is utilized to cool the hot plate 200 during operation of the metallurgical furnace 100 to prevent damage to the sidewall 125.

Cooling features 250 are provided on the outer surface 230 of the hot plate 200. The cooling features 250 are thermally coupled to the hot plate 200. The cooling features 250 extend from the outer surface 230 of the hot plate 200 in a spaced apart relationship. The cooling features 250 are arranged in a manner such that spray from the nozzles 284 comes in contact with at least some of the cooling features 250. The cooling features 250 are configured to enhance the cooling of the hot plate 200 by the spray cool system 280. The cooling features 250 are arranged to allow the spent coolant to flow down the outer surface 230 substantially without creating coolant separation zones on the outer surface 230 below the cooling features 250. Stated differently, the cooling features 250 are shaped and oriented to substantially prevent an area of the outer surface 230 downstream, relative to the flow of coolant running across the outer surface 230, of the cooling features 250 from in not receiving coolant flowing across the outer surface 230 as the coolant passes the cooling features 250. The cooling features 250 may be applied in areas of high heat on the hot plate 200. For example the cooling features 250 may be applied in areas of the hot plate 200 more likely to have high heat load such as near the hearth 115, near a burner port, slag retainers 240, or where flames from a burner contact the hot plate 200, while areas of the hot plate 200, such as near the roof 125, may have less or even be void of the cooling features 250. In this way areas of high heat can be more efficiently cooled, prolonging the life of the sidewall 125.

Additionally or in the alternative, cooling features 250 may also be provided to improve cooling of the roof 105 of FIG. 1. FIG. 2B illustrates a cross section for a roof 105 of FIG. 1. The roof 105 has a sidewall 220 adjoining the cover plate 205. The sidewall 220 is connected to a bottom surface 234 by the hot plate 200. The hot plate 200 in the roof 105 is substantially similar, though not the identical, to the hot plate 200 of the sidewall 125 and for purposes of this disclosure, will be discussed similarly.

The roof 105 has a central opening 175 configured to allow electrodes to extend therethrough and heat the material within the interior volume 135. The central opening 175 has a sidewall 220 extending from the cover plate 205 to the bottom surface 234. The sidewall 220, cover plate 205, hot plate 200, and a bottom surface 234 surrounds an enclosed space 291 of the roof 105. The hot plate 200 and bottom surface 234 of the roof 105 is exposed to elevated temperatures in the interior volume 135 of the metallurgical furnace 100.

The roof 105 has a spray-cooling system inside the enclosed space 291 substantially similar to spray cooling system 280 disposed in the sidewall 125. The spray cooled system 280 is configured to cool the roof 105. That is, the spray-cooled system 280 has a header 282 and a plurality of nozzles 284. The header 282 provides a coolant 286 to the nozzles 284 for spraying the coolant on the interior surfaces of the roof 105, such as the sidewall 220, hot plate 200 and bottom surface 234. One or more of the nozzles 284 may be inside the roof 105 or aligned to spray the coolant 286 on the hot plate 200. The outer surface 230 of the hot plate 200 is exposed to the enclosed space 291.

Cooling features 250 are provided on the outer surface 230 of the hot plate 200 in the roof 105. The cooling features 250 are thermally coupled to the hot plate 200. The cooling features 250 are arranged in a manner such that spray from the nozzles 284 is directed at them. The cooling features 250 are configured to enhance the cooling of the hot plate 200 by the spray cool system 280. As such, the cooling features 250 are arranged to allow drainage of the spent coolant out one or more of coolant drains 252.

The cooling features 250 disclosed above in the roof 105 and sidewall 125 may be arranged in a variety of patterns, shapes and configurations to promote not only heat removal from the hot plate 200 but also removal of the spent coolant from the roof 105 and sidewall 125. Testing was performed to arrive at a shape, number of features and topological orientation of the cooling features 250. Unexpectedly, different example results showed not all examples performed nearly as effectively as other examples. The following discussion of the enhanced cooling features 250 will disclose the examples tested to arrive at the preferred shape, number of features and topological orientation of the cooling features 250.

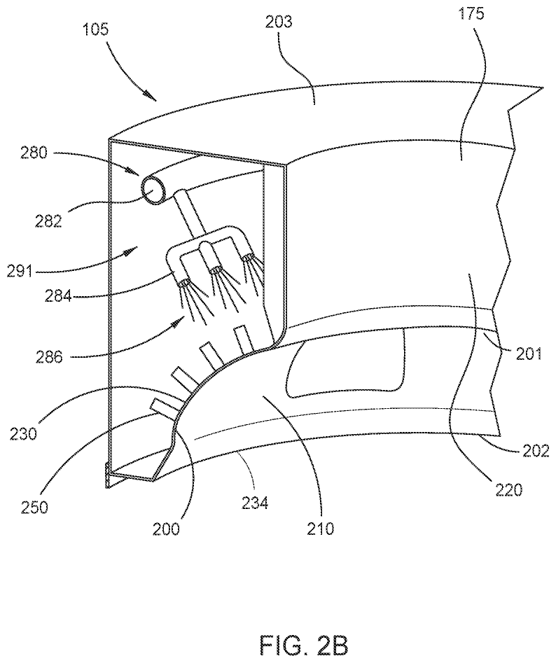

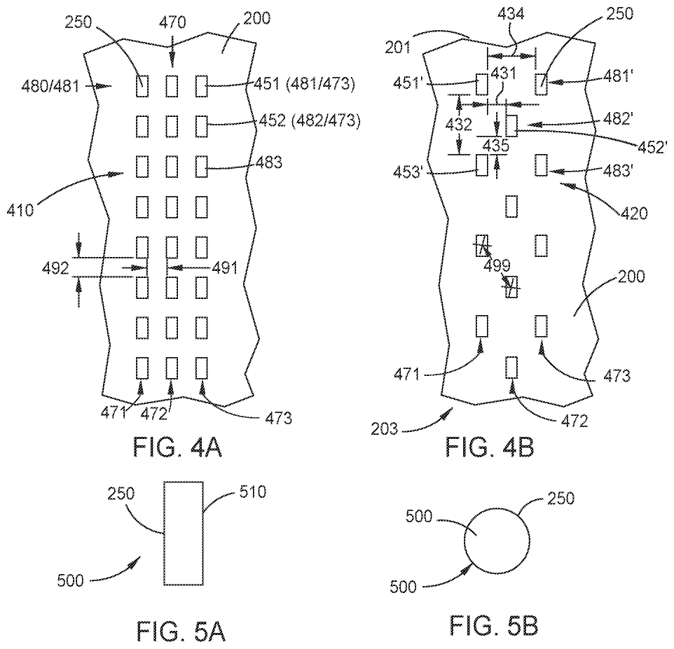

FIGS. 3A-3F will be discussed in conjunction with FIGS. 5A and 5B. FIGS. 3A-3F are schematic elevation views of various patterns of cooling features which may be utilized on the sidewall illustrated in FIG. 2A or roof illustrated in FIG. 2B. FIGS. 5A and 5B illustrate possible cross-sectional shape 500 variations for the cooling features. The cooling features 250 are expressed in 2D shapes when viewed from above or in cross-sectional plane parallel to the hot plate 200. It is understood that the hot plate 200 is curved. Thus, when stating the cross-section plane is parallel to the hot plate 200, it is intended to refer to a tangent to a point where the cooling feature 250 contacts the hot plate 200. The cross-sectional slice has a cross-sectional shape 500. In one example, the cross-sectional shape 500 is that of a rectangular shape 510. The rectangular shape 510 of the cooling features 250 may have adjacent sides which are not equal in length. Alternately, the rectangular shape 510 may have equal length sides. That is, the rectangular shape 510 may be that of a square. In another example, the cross-sectional shape 500 is that of an ellipsoid shape 520. The ellipsoid shape 520 may have major and minor axis. The major axis may be substantially axially aligned with gravity, or vertically. In other words, the major axis is substantially aligned from the top 201 of the hot plate 200 to the bottom 203 of the hot plate 200. For example, parallel with a centerline of the roof 105 or sidewall 125. Alternately, the ellipsoid shape 520 may have a major axis equal to the minor axis. That is, the ellipsoid shape 520 may be a circle.

Various test for cooling efficiency was devised to determine the optimum cross-sectional shape 500. In one example, the ellipsoid shape 520 having a major axis and minor axis between about 2.00 inches and about 3.00 inches exhibited excellent heat removal and cooling properties. For example, cooling features 250 having the ellipsoid shape 520 being circular in shape with a 2.63 inch diameter exhibited surprising results over the cross-sectional shape 500 being rectangular and square in shape. Furthermore, it was found that the ellipsoid shape 520 promoted shedding of the coolant in a manner that prevented a first cooling feature 250 from shading a second cooling feature 250 vertically below the first cooling feature.

The cooling features 250 may be welded or otherwise fastened to the hot plate 200 in an arrangement such that sprayed coolant moves down the cooling features 250 to a drain. The cooling features 250 may be substantially perpendicular to the hot plate 200. Alternately, the cooling features 250 may be angled on the hot plate 200 to promote a line of sight between the cooling features 250 and coolant sprayed from the spray cool system 280 to ensure coolant from the spray cool system 280 hits the cooling features 250. The cooling features 250 may extend a distance 336 from the hot plate 200. The distance 336 each cooling feature 250 extends from the hot plate 200 may or may not be the same. For example, the distance 336 the cooling features 250 extend from the hot plate 200 may be greater the further the cooling features 250 are away from the nozzles 284 of the spray cool system 280. Alternately, the distance 336 the cooling features 250 extend from the hot plate 200 may be greater the further the cooling features 250 are away from the top to the hot plate 200. The cooling features 250 may extend a distance between about 1.50 inches to about 10 inches, such as about 2 inches to about 5 inches. In one example, the cooling features 250 extend a distance of about 3 inches or less.

Turning to FIG. 3A-3B, the cooling feature 250 may be a rectangular fin shape 310. The rectangular fin shape 310 is oriented in a vertical manner to prevent water from pooling on the cooling feature 250 or creating regions on the hot plate 200 that are not wetted by coolant below the cooling feature 250. Spacing between horizontally adjacent cooling features 250 having the rectangular fin shape 310 may be optimize to promote spray along the entire surface of the rectangular fin shape 310.

Turning to FIG. 3C-3D, the cooling feature 250 are illustrated as a series of studs 320. The studs 320 may have a width 324. The width 324 of the studs 320, when square, corresponds to a length of an edge side. The width 324 of the studs 320, when round, corresponds to a diameter. In the example depicted in FIGS. 3C-3D, the studs 320 have a circular cross-section. Although each cooling feature 250 is shown with the width 324 being equal, it is contemplated that the width 324 for each cooling feature 250 may be adjusted based heat load. A spacing 322 is provided between the studs 320. The spacing 322 between adjacent vertically arranged studs 320 may be even. Alternately, the spacing 322 between adjacent vertically arranged studs 320 may be different. The spacing 322 between vertically adjacent studs 320 may be optimize to promote spray along the entire surface of each cooling feature 250. It has been found that the studs 320 shed water and promote better draining of the spent coolant than the fin shape 310 while importantly promoting the flow of coolant around the stud 320 to quickly rejoin, thus substantially preventing dry spots on the hot plate 200 below the studs 320.

Turning to FIG. 3E-3F, the cooling feature 250 are illustrated as a series of pins 330. The pins 330 may be square or round. In one example, the pins 330 have a cross-section having the ellipsoid shape 520 being circular, i.e., the major axis equals the minor axis. The pins 330 have a width 334 measured at a cross-sectional slice of the cooling features 250. In one example, the width corresponds to a diameter of the pins 330. The pins 330 are spaced a distance 332 from adjacent vertical pins. The distance 332 may be the same or greater than the width 334 of the pins 330. In one example, the distance 332 between the pins 330 is greater than four times the width 334 of the pins 330. The width 334 of the pins 330 may be optimized for removing heat from the hot plate 200. It should be appreciated that the width 334 of each pin 330 may or may not be exactly the same depending on heat load. In one example, the width 334 of the pins 330 are between about 1.75 inches and about 3.50 inches.

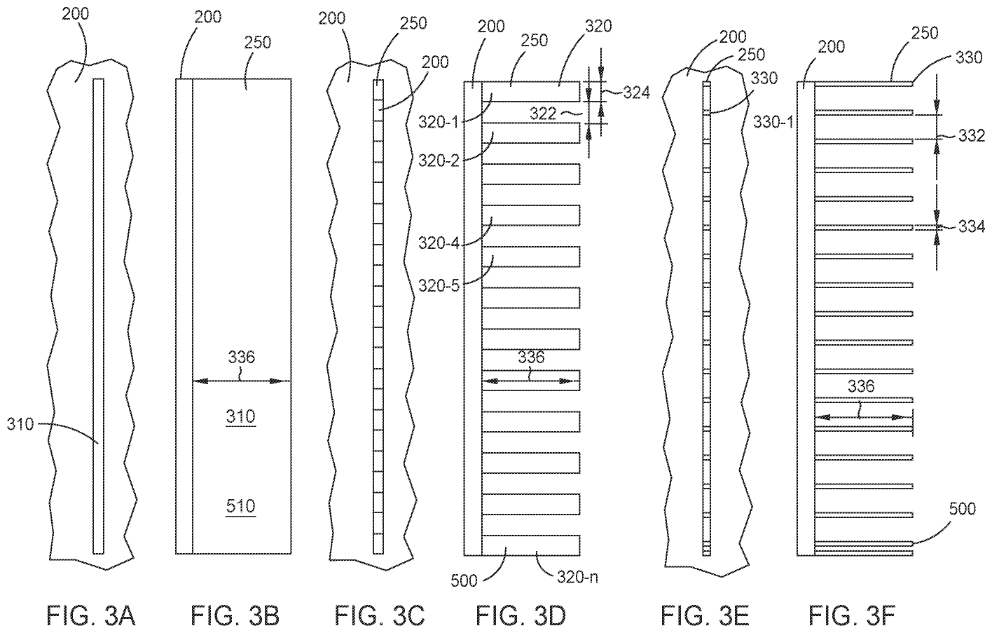

FIGS. 4A-4B are schematic plan views of topological patterns for the cooling features 250 which may be utilized on the sidewall illustrated in FIG. 2A or roof illustrated in FIG. 2B. The topological patterns of the cooling features 250 are shown with a vertical orientation to the page in FIGS. 4A-4B. It should be appreciated that the topological patterns of the cooling features 250 may be vertically aligned in practice, such as with gravity. The topological patterns of the cooling features 250 are provided to shed spent cooling fluid from a first cooling feature 451 without impinging on the effectiveness of a second cooling feature 452 lower on the hot plate 200. For example, spent warm coolant shedding from the first cooling feature 451 may fall on the second cooling feature 452 and diminish the cooling capacity of sprayed colder coolant directed to the second cooling feature 452. Additionally, the first cooling feature 451 may shade the second cooling feature 452 and partially block coolant directed at the second cooling feature 452.

FIG. 4A illustrates a first topological pattern 410 for the cooling features 250. The first topological pattern 410 may have rows 480 and columns 470 of cooling features 250. The cooling features 250 may have any cross-sectional shape described above with respect to FIGS. 5A and 5B. The cooling features 250 may have any number of rows 480, such as a first row 481, a second row 482, a third row 483, etc. The cooling features 250 may have any number of columns 470, such as a first column 471, a second column 472, a third column 473, etc.

The rows 480 may have row spacing 491 corresponding to a first distance. The columns 470 may have column spacing 492 corresponding to a second distance. It should be appreciated that the column spacing 492 may or may not equal the row spacing 491. It should also be appreciated that the column spacing 492 between the first column 471 and second column 472 may or may not be equal to the column spacing 492 between the second column 472 and the third column 473. Additionally, it should be appreciated that the row spacing 491 between the first row 481 and second row 482 may or may not be equal to the row spacing 491 between the second row 482 and the third row 483.

In another example, the first topological pattern 410 has equal row spacing 491 between each row 480 of cooling features 250. In another example, each row 480 may be spaced according to heat load on the hot plate 200, such that the row spacing in hotter areas are closer together than cooler areas of the hot plate 200. Additionally, the rows 480 of cooling features 250 may be positioned only in portions of the hot plate 200 experiencing high heat load, such as opposite slag retainers 240.

In one example, the first topological pattern 410 has equal column spacing 492 between each column 470 of cooling features 250. In another example, each column 470 of cooling features 250 may be spaced according to heat load on the hot plate 200. For example, the column spacing in hotter areas, are closer together than cooler areas of the hot plate 200.

The cooling features 250 may be linearly aligned in both the rows 480 and the columns 470. For example, a first cooling feature 451 may be in a first row 481 and a third column 473. A second cooling feature 452 may be in a second row 482 and the third column 473. The first cooling feature 451 is topologically oriented directly over the second cooling feature 452. This provides an easy arrangement for installing the cooling features 250.

FIG. 4B illustrates a second topological pattern 420 for the cooling features 250. Similar, to the first topological pattern 410, the second topological pattern 420 may have rows 480 and columns 470 of cooling features 250. Alternately, the cooling features 250 may have a staggered pattern. The staggered pattern having been found to prevent pooling of spent coolant. As such a pattern is difficult to discuss, the discussion will proceed with respect to rows 480 and columns 470 to aid in understanding the possibilities in the arrangement of the cooling feature 250.

The first column 471 of cooling features 250 may be spaced a first distance 434 from a cooling feature 250 horizontally adjacent in the third column 473. Similarly, the first row 481 of cooling features 250 may be spaced a second distance 432 from the cooling features 250 vertically adjacent in the third row 483.

The second topological pattern 420 has a vertical offset 435 for cooling features 250 in an adjacent columns 470. Similarly, the second topological pattern 420 has a horizontal offset 431 for cooling features 250 in an adjacent row 480s. For example, a second row 482′ having a second cooling feature 452′ is both vertical offset 435 and horizontal offset 431 from the third row 483 having a third cooling feature 453′. Although shown vertically aligned, it should be appreciated that the cooling features 250 in the first row 481 may not align with the third row 483. In one example, the second topological pattern 420 has random horizontal offsets 431 between adjacent cooling features 250 to maximize the vertical spacing between adjacent cooling features 250. Similarly, the second topological pattern 420 may have random vertical offsets 435 between adjacent cooling features 250. In this manner, adjacent cooling features 250 are spaced apart to provide line of sight unimpeded access to coolant being sprayed from the nozzle 284.

It was unexpectedly found that setting the cooling features 250 in a topological geometric pattern of about 7 inches to about 3 inches on center, i.e., the next adjacent cooling feature 250, as shown by the arrow 499, enhances spray cooling by providing a substantial density of cooling features 250 sprayed with coolant form the nozzles 284. In one example, the cooling features 250 are in a pattern 4 inches on center. In another example, the cooling features 250 are in a pattern 6 inches on center. Additionally, staggering the pattern of the cooling features 250, as opposed to having rows, has been found to prevent water channels from forming wherein the coolant channels downward along a side face of the cooling feature 250 reducing the cooling capabilities of cooling features 250 positioned below by reducing the amount of coolant contacting those cooling features 250. The cooling features 250 having round shaped studs were additionally found to perform better than rectangular shaped fins. The cooling features 250 having round shaped studs do not blocked water spray or provide shading to additional cooling features 250. Placement of the cooling features 250 in high heat areas, such as opposite the slag retainers, or near the O₂ burners, help reduce the temperature of these areas. The cooling features 250 were found to remedy slag wash off from the slag retainers 240 due to the high heat load on the hot plate 200 in the areas of the slag retainers 240. Thus, the cooling features 250 shaped and arranged as described above were found to enhance spray cooling of the hot plate 200 and reduce the amount of coolant used and removed. Thus, the cooling features 250 reducing the operational costs of the spray cooled metallurgical furnace.

While the foregoing is directed to embodiments of the present disclosure, other and further embodiments may be devised without departing from the basic scope thereof, and the scope thereof is determined by the claims that follow.

What is claimed is:

1. A sidewall or roof for a metallurgical furnace, the sidewall or roof comprising:
a cover plate;
a hot plate coupled in a spaced apart relation to the cover plate, the hot plate and the cover plate defining an inner volume there between, the hot plate comprising:
an inner surface configured to face an interior volume of the metallurgical furnace;
an outer surface exposed to the inner volume and facing the cover plate; and
a plurality of cooling features extending from the outer surface of the hot plate in a spaced apart relationship into the interior volume; and
a spray cool system disposed in the inner volume and configured to spray coolant on the outer surface of the hot plate and into contact with the cooling features.

2. The sidewall or roof of claim 1, wherein the cooling features have a major axis substantially aligned with from a top to a bottom of the hot plate.

3. The sidewall or roof of claim 1, wherein a first cooling feature of the cooling features comprises:
a width measured at a cross-section of the first cooling feature; and
a length extending from the hot plate into the inner volume.

4. The sidewall or roof of claim 3, wherein the length of the first cooling feature is between about 2 inches to about 10 inches.

5. The sidewall or roof of claim 1, wherein the cooling features are pins, wherein at least one of the pins has a diameter about 1.75 inches and about 3.50 inches.

6. The sidewall or roof of claim 5, wherein the cooling features are arranged in rows and columns and wherein a first cooling feature in the first row is immediately adjacent a second cooling feature in a third row.

7. The sidewall or roof of claim 5, wherein the cooling features are arranged in a staggered pattern on the hot plate.

8. The sidewall or roof of claim 4, wherein the cooling features are studs having a square cross sectional shape.

9. A sidewall for a metallurgical furnace, the sidewall comprising:
a cover plate; and
a hot plate coupled in a spaced apart relation to the cover plate forming an inner volume of the sidewall, the hot plate configured to contact the molten material, a spray cool system disposed in the inner volume of the sidewall and configured to spray coolant on the hot plate, the hot plate comprising:
an inner surface configured to face an interior volume of a metallurgical furnace;
an outer surface exposed to the inner volume of the sidewall; and
a plurality of cooling features extending from the outer surface of the hot plate in a spaced apart relationship wherein the cooling features are configured to enhance the cooling of the hot plate by the spray cool system.

10. The sidewall of claim 9, wherein the cooling features have a major axis substantially aligned with from a top to a bottom of the hot plate.

11. The sidewall of claim 9, wherein the cooling features comprises:
a width measured at a cross-section of the cooling features; and
a length, wherein the cooling features extend their length from the hot plate.

12. The sidewall of claim 11, wherein the length of the cooling features is between about 2 inches to about 10 inches.

13. The sidewall of claim 12, wherein the cooling features are pins and the width of the cooling features correspond to a diameter of the pins and wherein the width is between about 1.750 inches and about 3.500 inches.

14. The sidewall of claim 13, wherein the cooling features are arranged in rows and columns and wherein a first cooling feature in the first row is immediately adjacent a second cooling feature in a third row.

15. The sidewall of claim 13, wherein the cooling features are arranged in a staggered pattern on the hot plate.

16. The sidewall of claim 12, wherein the cooling features are studs having a square cross sectional shape.

17. A metallurgical furnace comprising:
a hearth,
a sidewall sitting on the hearth; and
a roof disposed on the sidewall, the hearth, sidewall and roof defining an interior volume of the metallurgical furnace, the interior volume configured for processing molten material, the sidewall and roof comprising:
a cover plate; and
a hot plate coupled in a spaced apart relation to the cover plate forming an inner volume of the roof, the hot plate configured to face the inner volume, a spray cooled system disposed in the inner volume of the roof and configured to spray coolant on the hot plate, the hot plate comprising:
an inner surface configured to face an interior volume of a metallurgical furnace;
an outer surface exposed to the inner volume of the sidewall; and
a plurality of cooling features extending from the outer surface of the hot plate in a spaced apart relationship wherein the cooling features are configured to enhance the cooling of the hot plate by the spray cool system.

18. The metallurgical furnace of claim 17, wherein the cooling features comprises:
a width measured at a cross-section of the cooling features taking in a plane of the hot plate; and
a length, wherein the cooling features extend their length from the hot plate and the length of the cooling features is between about 2 inches to about 10 inches.

19. The metallurgical furnace of claim 18, wherein the cooling features are pins and the width of the cooling features correspond to a diameter of the pins and wherein the width is between about 1.750 inches and about 3.500 inches.

20. The metallurgical furnace of claim 18, wherein the cooling features are arranged in a staggered pattern on the hot plate.
